(19) United States
(12) Patent Application Publication
(10) Pub. No.: US 2017/0344900 A1
(43) Pub. Date: Nov. 30, 2017

(54) METHOD AND APPARATUS FOR AUTOMATED ORGANIZATION OF VISUAL-CONTENT MEDIA FILES ACCORDING TO PREFERENCES OF A USER

(71) Applicant: Sultan Saad ALZAHRANI, Tempe, AZ (US)

(72) Inventor: Sultan Saad ALZAHRANI, Tempe, AZ (US)

(21) Appl. No.: 15/163,414

(22) Filed: May 24, 2016

(51) Int. Cl. G06N 99/00; G06F 17/30

(52) U.S. Cl. CPC G06N 99/005; G06F 17/30864; G06F 17/30029; G06F 17/30038

(57) ABSTRACT

A method and apparatus are provided for organizing media files using parameters obtained from the visual content and metadata of the media files. Using machine learning, an algorithm is trained to apply user preferences to organize the media files. The user indicates their preferences by viewing the media files and selecting relevancy measures and organizational actions for a subset of the media files (i.e., training data). Using the media-file parameters, the algorithm calculates relevancy values for respective media files. The algorithm is trained to minimize the error between the calculated relevancy value and the user determined relevancy measures of the training data. The media-file parameters can include, e.g., the blurriness of and facial and pattern recognition of the visual content; the source, location, time, edit history, and the frequency and recency of access to the media files as recoded in the metadata.

### GRANT OF NON-EXCLUSIVE RIGHT

This application was prepared with financial support from the Saudi Arabian Cultural Mission, and in consideration therefore the present inventor has granted the Kingdom of Saudi Arabia a non-exclusive right to practice the present invention.

### BACKGROUND

### Field

This disclosure relates to machine learning to train an algorithm to assign relevancy values and automatically organize a user's visual-content media files in accordance with the user's preferences, and, more particularly to organizing media files using training data that includes user determined relevancy measures indicating the user's organizational preferences for the media files in the training data.

### Description of the Related Art

As technology progresses, tacking, storing, and sharing higher quality pictures using personal digital devices (PDDs) has become easier and less expensive. For example, digital images taken using a smartphone can be stored on the cloud using Google Drive™ or Dropbox™. Additionally, digital images can be edited and shared using Instagram™ and social media. PDD's can include smartphones, cellular phones with digital cameras, digital cameras and video recorders, tablet computers, personal computers, and wearable technology such as smartwatches, smartglasses, etc.

With the easy of taking and storing digital images using, e.g., a screen-capture function of a PDD or a camera function of the PDD the number of pictures accumulated and stored on the internal memory of the PDD and on remote storage accessible by the PDD has increased with time. Although the number of pictures has increased together with increases in user's abilities to take and store pictures, the user's time and capacity to sort through and organize pictures has not kept pace. Moreover, several media sharing platforms (e.g. Instagram, Snapchat, Pinterest, WhatsApp, etc.) have exacerbated the dramatic increase in media accumulation by contributing to a media culture that creates, shares, and distributes media to an unprecedented degree. Accordingly, many users are overwhelmed by having a large inventory of old pictures that they lack to time for are unwilling sort through in order organize and/or to delete unwanted images. Yet at the same time, these users are unwilling to discard all of their pictures for fear that some of the images might be precious memories or otherwise have great significance to the user. In contrast to previous decades during which storage limitations would constrain users to organize, cull through, and discard unwanted pictures before the task became unmanageable, today the number of stored photographs on a PDD can be very large before a user is faced with a decision of discarding unwanted images. According to Kryder's law, the storage capacity of digital memories has increased exponentially along lines similar to Moore's law for processing power. The increases in storage capacity take together with commensurate developments in media sharing, microblogging, and social networks has resulted in an unwieldy task of organizing visual-content media files that is beyond the capability or interests of many users.

### SUMMARY

A method and apparatus is provided for organizing media files using parameters obtained from the visual content and metadata of the media files. Using machine learning, an algorithm is trained to apply user preferences to organize the media files. The user indicates their preferences by viewing the media files and selecting relevancy measures and organizational actions for a subset of the media files (i.e., training data). Using the media-file parameters, the algorithm calculates relevancy values for respective media files. The algorithm is trained to minimize the error between the calculated relevancy value and the user determined relevancy measures of the training data. The media-file parameters can include, e.g., the blurriness of and facial and pattern recognition of the visual content; the source, location, time, edit history, and the frequency and recency of access to the media files as recoded in the metadata.

It is to be understood that both the foregoing general description of the invention and the following detailed description are exemplary, but are not restrictive of the invention.

### BRIEF DESCRIPTION OF THE DRAWINGS

A more complete understanding of this disclosure is provided by reference to the following detailed description when considered in connection with the accompanying drawings, wherein:

FIG. 1 shows a flow diagram of a method of training a relevancy algorithm, according to user preferences, to automatically organizing visual-content media files, according to one implementation;

FIG. 2 shows a flow diagram of a process of training a relevancy algorithm to minimize a cost function between user determined relevancy measures and relevancy values calculated using the relevancy algorithm, according to one implementation;

FIG. 3 shows a media-file parameters that can be used in the relevancy algorithm to calculate the relevancy values, according to one implementation;

FIG. 4 shows a schematic diagram of a K-layer artificial neural network (ANN) included in the relevancy algorithm, according to one implementation;

FIG. 5 shows a flow diagram of a process of calculating the relevancy values using an ANN, according to one implementation;

FIG. 6 shows a flow diagram of a process of calculating the relevancy values using a convolution neural network (CNN), according to one implementation;

FIG. 7 shows a flow diagram of a process of adjusting the relevancy algorithm weights based on supplemental training data, according to one implementation;

FIG. 8 shows a flow diagram of a process of sorting and storing media files according to the calculate the relevancy values, according to one implementation;

FIG. 9 shows a schematic diagram of a personal digital device to perform parts of the method of training and automatically organizing visual-content media files using a relevancy algorithm, according to one implementation;

FIG. 10 shows a schematic diagram of remote computer hardware to perform parts of the method of training and automatically organizing visual-content media files using a relevancy algorithm, according to one implementation; and

FIG. 11 shows a schematic diagram of a cloud computer system to perform the method of training and automatically organizing visual-content media files using a relevancy algorithm, according to one implementation.

### DETAILED DESCRIPTION

With the revolution of the digital era where the storage capacity of digital memories doubles approximately annually and the commensurate developments in media sharing, microblogging, and social networks, many users would benefit from an automated or semi-automated method of sorting among photographs and digital images to select those of higher value to keep and others of medium or low value to be compressed and archived or discarded. Further the method could sort the images accordingly to predefined and/or user defined metrics to provide the user with more tractable management of their digital media. Thus, users can benefit from automated judgments regarding the value of the media files and judgements of which media files to keep and which to delete. Therefore, even though users take a lot of images, download a lot of other images through social networks and the like, and save these images to their personal digital devices (PDDs), these same users do not have to spend significant amounts of time to sorting through these images to variously keep, archive, and discard the images.

The methods described herein provide automated organization of media files that include visual content (e.g., digital images) stored in a user's PDD. The methods described herein can be performed by calculating a relevancy value that represents the relevance of a given digital image to a user. Factors influencing the relevancy values can include, e.g., whom where, when, and how the media file was generated, the access history and edit history of the media file, and the patterns and features represented in the visual content of the media file.

Generally, the methods described herein use the relevancy values calculated for the media files to select a user preferred organizational action to be performed on the corresponding media files. For example, media files having a high relevancy value can be stored in an easily accessible frequent-usage folder, whereas media files having a low relevancy value can be moved to lower rank folders, archived, or even discarded. Additionally, the relevancy values can indicate relevancy for a particular field or interest. For example, the relevancy value can be multi-dimensional having respective dimension for categories such as family, work, school, hobby “A,” hobby “B,” etc. In this case the relevancy value still has application for the organization of media files (e.g., organizing media files respectively into folder corresponding to family, work, school, hobby “A,” hobby “B,” etc.). Additionally, the relevancy values also can have benefit in a search engine and for helping a user find media files that are similar to and/or highly correlated with a given media file or task.

In certain implementations, the elevancy measure can be used to improve utilization media storage space in the users PDD by providing the user with a hierarchy of options for storing media files according to relevancy ranging from: storing the most relevant files in a favorites/frequently used folder; to storing medium relevancy files in a backup folder or in remote storage (e.g., in the cloud); and to archiving or deleting irrelevant media files.

Here media files can be any of a wide range of media files and formats, including, e.g., still images having formats such as MEPG, JPEG, graphics interchange format, Bayer pattern formats, and raw file formats and moving images having formats such as digital video file, motion JPEG, and raw file formats. A PDD can be can be a smart phone, cellular phone, tablet computer, digital camera, a video camera, a personal or desktop computer.

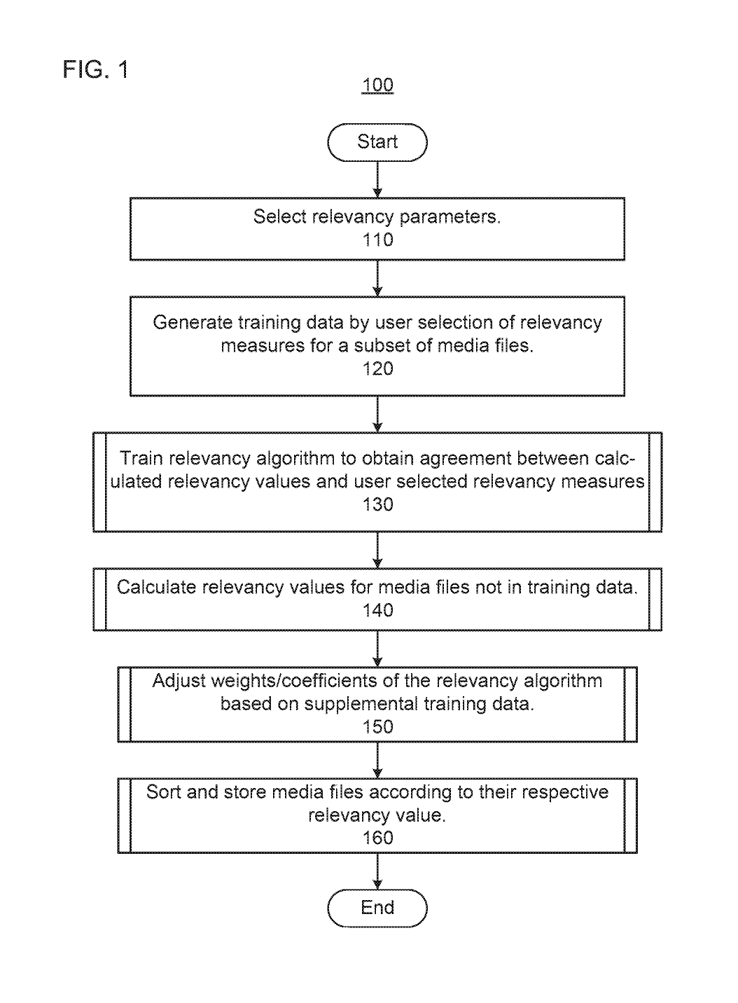

Referring now to the drawings, wherein like reference numerals designate identical or corresponding parts throughout the several views, FIG. 1 shows a method 100 of organizing media files. For example, the method can be performed to organize media files using internal memory of a PDD, or using remote storage such as cloud storage, a network-database storage, or a file sharing service. Additionally, the method can be performed using a combination of internal storage and logic processing on the PDD of the user together with remote storage and remote logic processing using cloud based computing, for example. In certain implementations, the less computational intensive, power intensive, and memory intensive portions of method 100 can be performed on the PDD, which can be constrained in power, size, and computational and memory resources, while more computational intensive, power intensive, and memory intensive portions of method 100 can be performed more economically using cloud computing, which is not as severely constrained with respect to power, size, and computational and memory resources.

For example, media files that are infrequently used and/or have been archived can be stored using cloud storage, whereas frequently used media files can be stored on the memory of the PDD. Further, computationally intensive tasks, such as training the relevancy algorithm can be performed using cloud computing, whereas less computational intensive tasks, such as sorting the media files using the relevancy algorithm can be performed using a processor of the PDD.

In step 110 of method 100, a user can select among various parameters to be considered when determining the relevancy measure. A default configuration of the relevancy parameters can also be used, when a user elects to not select among various relevancy parameters. In certain implementations, the relevancy parameters can also be used to determine subscriptions to various sources of online media (e.g., a subscription to a podcast). In these cases the default configuration of the relevancy parameters can also be used to allow more media files to be automatically downloaded from different broadcasting services with no prior requirement of user supervision of storing such media.

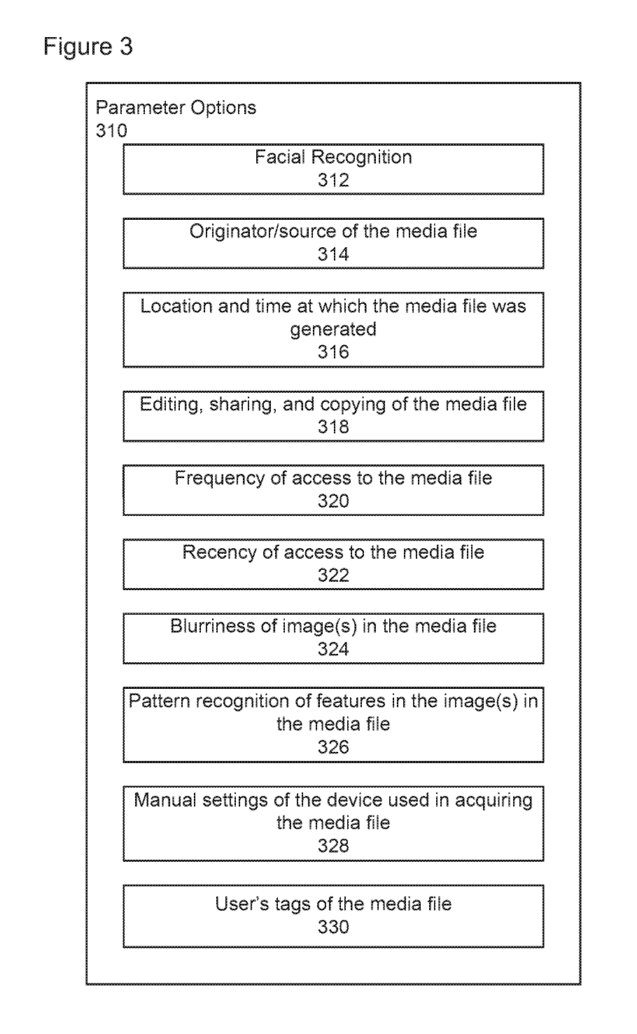

In certain implementations, the relevancy parameters can be hard wired, such that the user does not elect among various relevancy parameters. FIG. 3 shows an example of a set 310 of parameters that can be considered when determining the relevancy values. For example, when the user is provided the option of selecting among the relevancy parameters, the user can be provided with a radio button to turn on or off various of the relevancy parameters.

Parameter 312 indicates facial and/or object recognition can be one of the relevancy parameters. In certain implementations, facial recognition can include generally distinguishing between those digital images that include faces/objects from those digital images with no faces. Additionally, the facial-recognition parameters 312 can include determining the number of faces within each digital image. In certain implementations, the selection of the facial-recognition parameters 312 can include the feature of identifying and tagging individuals detected in a given digital image with the individuals names. For example, when a user has a contact list with profile images of the user's contacts, correlations between the profile images, or other images that are known to be associated with the user's contacts can be used to identify and assign or recommend tags or faces that have been recognized using facial recognition methods.

The facial-recognition parameters 312 can be applied to variously indicate the relevancy of a media files. For example, for users who prize interpersonal relationships, a media file that includes faces/objects and especially faces of people that are in the user's contact list can be an indicator that the images are important and relevant to the users. In contrast, other users that highly prize hobbies (e.g., a nature enthusiast or an automobile enthusiast) may prize images of places of things more than pictures of people. Using the facial recognition parameters 312 in the foregoing, machine learning can be used to train an algorithm to recognize how to organize media files in accordance with a given user's own preferences and selection patterns regarding which media files are relevant and important enough to store in an easily accessible file locations versus which media files are to be discarded and/or archived. Thus, in certain implementations, the relevancy parameters, such as the facial-recognition parameters 312, provide signals to a relevancy algorithm that is trained using machine learning to calculate relevancy values indicating the user's organizational preferences for the media files. Thus, whether a given parameter for the set 310 is positively or negatively correlated with the organizational preferences (i.e., the user's relevancy measure) is determined by the individual preferences of the user.

Herein, the term “relevancy measure” designates a user defined preference, and the term “relevancy value” designates a value calculated by the relevancy algorithm. When the relevancy algorithm is trained to represent the user's preferences the differences between the user determined relevancy measure and the algorithm calculated relevancy value will be minimized for the training data. The parameters of set 310 relate to both the relevancy measure and the relevancy value. The parameters of set 310 relate to the relevancy value because the selected parameters of set 310 are used as inputs to calculate the relevancy values, and the user has determined relevancy measures of the training data). Relatedly, the parameters of set 310 relate to the relevancy measures because the selected parameters of set 310 are used for training the relevancy algorithm to capture patterns indicated by the user determined relevancy measures expressed in the training data discussed later.

Parameter 314 indicates that the originator or source of the media file can be used as a parameter in determining the relevancy values of the media files. The metadata of a media file can include information of who took the picture and when the picture was taken. Also, a picture that was obtained by copying from the internet, by taking a screen capture of a PDD's screen, or an image copied from another user's social media can include metadata information regarding the origin of the digital image.

Parameter 316 indicates the location and/or time at which the media file was generated. This information can be obtained from the metadata. For example, a PDD equipped with GPS or some other method of determining location (e.g., triangulation or indoor position determination using received signal strength indicators, WiFi, Bluetooth, Near Field Communication networks, etc.). The location and time can be used, for example, to determine media tiles that are more likely to have high importance or relevancy. For example, media files may be more relevant if they were obtained in close temporal or spatial proximity to other pictures of high relevancy, of if they were generated during holidays, or at an exotic vacation spot. For example, a user may regularly use a white board at work to collaborate with a team and archive the work on the white board using a digital camera function on the user's PDD. Then digital images taken at the end of a work day at the work location may signal that the digital images have a high relevancy and/or importance and are thus not to be discarded.

Parameter 318 indicates that the editing, sharing, and copying of a media file can be used to determine relevancy. Information regarding the editing, sharing, and copying of a media file can be found in the metadata of the media file, for example. When a user has taken the time and effort to edit of digital image, the image might have a greater likelihood of being an important image. Further, the improvements made by editing can increase the relevancy and importance of the image. Similarly, taking the time and effort to share and/or copy an image can indicate either an increase or a decrease in the relevancy and importance of the image, depending on the user's preferences. The relevancy and importance of editing, sharing, and copying of the image can be determined by correlating those parameters with the preferences of the user as indicated by user-determined relevance measures.

Parameter 320 indicates the frequency with which a user accesses a given media file can be used as an indicator of the relevancy and importance of the media file.

Parameter 322 indicates the recency with which a user accesses a given media file can be used as an indicator of the relevancy and importance of the media file.

Parameter 324 indicates the image quality and/or blurriness of the visual content of a media file can be used as an indicator of the relevancy and importance of the media file. For example, some users will take a digital image, and upon recognizing the image is blur immediately take a second clear digital image without deleting the blur digital image. Thus, two images are taken in close temporal and spatial proximity but one being blurry and the other being clear is likely a strong indicator that the blur image can be deleted and has a low relevancy to the user.

Parameter 326 indicates that pattern recognition can be used as an indicator of the relevancy and importance of the media file. For example, a user that takes images of whiteboard drawings to archive their work might value images of hand-drawn alphanumeric characters. Similarly, a car enthusiast might value digital images having patterns indicative of automobiles.

Parameter 328 indicates that manual settings of the user's PDD can be used as an indicator of the relevancy and importance of the media file. For example, when a user makes the effort to adjust or use manual settings in order to acquire an image, the user's additional effort can provide an indication that the image has higher value to the user than an image taken using automatic settings.

Parameter 330 indicates that the tags assigned by a user to a media file can be an indicator of the relevancy and importance of the media file. For example, when a user tags a media file with a name of a friend or family member and then exhibits a pattern the indicating that those media files in the training data that are thusly tagged have high relevancy, then it can likely be inferred that the remaining media files not in the training data but similarly tagged will also have high relevancy.

In step 120 of method 100, training data is generated. For example, a user can be asked to sort media files into several categories based on the user's preferences. In certain implementations, the user can be asked to sort the media files according to a scale of relevancy. For example, the media files can be sorted using a scale from one to ten, with one being the least relevant, and ten being the most relevant. For each media file in the training data, the user's preferences are expressed as a relevancy measure and recorded as part of the training data.

In certain implementations, a user can be asked to sort the media files along multiple dimensions. Regions within the multi-dimensional space can then be partitioned to correspond to various actions. For example, the media files can be organized along two axes, such as an importance axis, and a timeliness axis. The vector indicating both importance and timeliness can be the relevancy measure in this case. The important and timely media files can be placed in a highest relevancy folder. Important but not timely media files can be archived as relevant for later retrieval. Timely but not important media files can be placed in a file of perishable relevancy, such that after a relevancy expiration date, the perishable-relevancy file empties its contents to a trash folder, and unimportant and untimely media files can be immediately discarded to a trash folder.

In certain implementations, for example, the user can also be asked to sort the media files according to which files should be kept in easily accessible file folders, file folders of medium accessibility, archived/compressed in file folders that are not easily accessible with the benefit of economizing memory storage, and discarded to free memory storage.

In certain implementations, the user can be given an option of setting up and naming their own file structure (or assign/remove tags). For example, the user can setup up and organize separate files according to categories of work, personal, hobbies, etc. The placements by the user of the media files into various files or categories is then tracked and recorded as the relevancy measure, such that the relevancy is to the user defined categories. The media files sorted by the user and the user's actions in sorting of the media files become the training data.

In certain implementations, the user self-selects the media files to be sorted for the training data. In another implementation, an automated algorithm selects the media files to include a wide range of media files exhibiting parameter values that are representative all of the media files.

In certain implementations, more than one user can use the PDD, and each user can have an independent set of training data representing the organization preferences of the user. The training data of the respective users can be saved in separate files and can be recalled when the respective users login to the PDD or when requested by the users.

In certain implementations, the relevancy measure indicating the user's preferences can be entered into the PDD using an alphanumeric character or string to represent the user's preference for respective media files of the training data.

In certain implementations, a user can signal the relevancy measure indicate their preference by swiping an image or a thumbnail in a predetermined direction; the image or thumbnail representing the visual content of the media file in a predetermined direction. For example, swiping up can signal a highest relevancy measure; swiping right can signal a medium relevancy; swiping left can signal a low relevancy measure; and swiping down can signal a lowest relevancy measure.

In certain implementations, a user can indicate their preference by dragging and dropping the media files into bins/folders signaling various relevancy measures. As would be understood by one of ordinary skill in the art, any known means can be used for signaling a user's preferences of the relevancy measures of the training data media files.

In process 130 of method 100, the training data is used to train the relevancy algorithm. Coefficients and weights in the relevancy algorithm are adjusted to minimize an error between the calculated relevancy values and the user-determined relevancy measures. Thus, the relevancy values calculated by the relevancy algorithm can be used to robustly and automatically organize the remaining media files that are not part of the training data in accordance with the user's preferences as indicated by the relevancy measures. For example, when the relevancy measure is expressed using a scale from one to ten, the relevancy value is also generated using a scale ranging from one and ten. For a given media file of the training data, an error can be calculated by taking the difference between user-defined relevancy measure and the corresponding calculated relevancy value. A total error can then be calculated by taking a predefined norm of the all of the errors for the training data (e.g., the L₁-norm or the L₂-norm). The coefficients and weights of the relevancy algorithm used to calculate the relevancy value can be trained to minimize the total error (e.g., using a gradient search method, simulated annealing, or other known method). Additionally, the coefficients and weights of the relevancy algorithm can be minimized subject to a sparsity or regularization constraint (e.g., by penalizing the coefficients and weights when the L₁-norm or the L₀-norm is larger).

The relevancy algorithm can take several forms, including a weighted sum or an artificial neural network (ANN), such as a shallow ANN like an autoencoder ANN or a deeper ANN like a convolution neural network (CNN). When the relevancy algorithm is a weighted sum, the relevancy value RV can be given by

$$RV = {\sum }_{i = 1}^{N} {w}_{i} {f}_{i} ( {p}_{i} ) + {\sum }_{i = 1}^{N} {\sum }_{i \neq j}^{N} {w}_{ij} {g}_{ij} ( {p}_{i} , {p}_{j} )$$

wherein wᵢ is a weight corresponding to the parameter pᵢ and N is the number of parameters. The function fᵢ(pᵢ) linearizes the i^{th} parameter and corrects for an offset between the range of the relevancy value and the range of the i^{th} parameter (e.g., if the relevancy value has a range of [1,10] and the i^{th} parameter has a range of [−1,1] then the function fᵢ(pᵢ) can map the i^{th} parameter onto a range of [1,10]). The second term in the relevancy value RV can be used to account for correlations between parameters that are indicative of relevancy. For example, even if neither parameter pᵢ or pⱼ taken separately is indicative of relevancy, the combination might indicate relevancy.

Consider, an example of a user that demonstrates a pattern of taking series of similar digital images of a group of people within a short period of time in order to get at least one picture of good quality (e.g., good quality being that the picture is not blurry and everybody in the pictures has their eyes open, is smiling, etc.). Then after taking the series of digital images, the user selects the best one or two from the series to keep and discards the rests. This pattern can be discerned through machine learning in which correlations between parameters are considered. For example, the signals provided by parameters indicating close temporal proximity, absence of blurriness, and/or faces with open eyes might separately be insufficient to conclude that a media file be saved, but a confluence of these parameters might provide a strong signal that a media file is highly relevant to the user. Accordingly, using correlations and two parameter weighting as shown above for the relevancy value RV, an automated algorithm can interpret and apply the above pattern of behavior to recognize relevant media files, even though a single parameter weighting might not reveal a pattern. Thus, a two parameter weight wᵢⱼ multiplied by a two parameter linearization function gᵢⱼ(pᵢ,pⱼ) that is obtained using the covariance between the parameters pᵢ and pⱼ can be used to express two parameter relevancy effects not captured by the single parameter weight wᵢ or wⱼ.

When the relevancy algorithm is optimized in process 130, the weight coefficients wᵢ and wᵢⱼ can be adjusted to minimize the total error introduced in the foregoing. In certain implementations, the linearization functions fᵢ(pᵢ) and gᵢⱼ(pᵢ,pⱼ) can include polynomial curve-fit functions. To improve the linearization of the parameters pᵢ and pⱼ, in certain implementations, the polynomial coefficients of the curve-fit functions can also be optimized in concert with the optimizing of the weights wᵢ and wᵢⱼ to minimize the total error.

Ultimately, the relevancy value is used in step 160 to determine what action is to be taken for a given media file. For example, if the relevancy values range from one to ten, one being the least relevant and ten being the most relevant, those media files having a relevancy value in the interval [7,10] can be assigned an action of being stored in the frequent-use folder. Those media files having a relevancy value in the interval [4,7) can be assigned an action of being compressed and stored in an archive folder. Finally, those media files having a relevancy value in the interval [1,4) can be assigned an action of being placed in a trash folder. Thus, in accordance with the user's preferences, certain thresholds values (e.g., 4 and 7) can demark boundaries between the organization actions of deleting, archiving, and moving the media files to a frequent-use folder.

In certain implementations, when the parameters need to be a nonlinear function, the parameters can be transformed to another space to resolve problems created by linearity limitations in order to provide a better kernel function in the linear regression function represented by the relevancy value RV.

Generally, the primary role of the relevancy values is to provide a metric for assigning organizational actions, as discussed in the foregoing. Thus, when a relevance value is near the center of a range for a given organizational action, small errors in the relevance value might not be outcome determinative because small errors will not display the relevancy value across an action boundary into a different organizational action. Additionally, while the error signal and the relevancy value can be continuous, they do not have to be. In fact, in addition to the organizational action being discrete, the relevancy measures are typically discrete, and thus the error signal can also be coarse grained and discretized.

In certain implementations, the relevancy value can be discrete rather than continuous values, reflecting the discrete number of organizational actions that can be taken with respect to the media files. Further, in certain implementations, there can be a one-to-one correspondence between the discrete relevancy values and the organizational actions to be taken on the media files. For example, the organizational actions can be (i) store in a frequent-use folder, (ii) compress and store in an archive folder, and (iii) discard into a trash folder.

As an alternative to using a linear regression function and/or correlations to represent by the relevancy value RV, a statistical machine learning algorithm such as neural network can also be used. A predefined number of layers and nodes, in an ANN for example, can be used to optimize predictions of organizational actions for respective media files. If neural network is used, there is no need to calculate a relevancy value distinct from the possible sorting actions. Rather, the relevancy value can be tied directly to and even labeled by the corresponding organizational actions. Thus, the relevancy value can have a one-to-one correspondence to an action.

In process 140 of method 100, the trained relevancy algorithm is used to calculate a relevancy value for all of the media files. Additionally, the relevancy algorithm can calculate a confidence value for each media file. The relevancy value represents an estimate based on the training data of the relevancy measure for a given media file. The confidence value represents a confidence that the estimate (i.e., the relevancy value) correctly represents the user's actual preferences. For example, if the media file is very similar to a statistically significant sample size of media files in the training data (i.e., the parameters of the media has a high correlation with relevant training data) and the similar media files in the training data were assigned a very narrow distribution of relevancy measures, then the confidence in the relevancy value is likely very high. However, if the number of similar media files in the training data is statistically insignificant or if there was a wide distribution of relevancy measures assigned to the similar media files in the training data, then the confidence is likely very low. When the confidence is low for many media files, the training data can be improved by supplementing the training data with supplemental training data from the media files with low confidence.

Additionally, when the confidence value is low and the consequences of incorrectly assigning a media files are high (e.g., the relevancy value indicates that the media file should be irreversibly discarded) then a safety margin or safety procedure can be applied to ensure that steps with severe consequences are not taken based on insubstantial correlations or a statistically insufficient sample size. For example, low relevancy and low confidence media files can be flagged for review by the user or the organizational action can be hedged by increasing the relevancy value by a value calculated using the confidence value or by applying the organizational action of the next highest relevancy value interval when the confidence value falls below a predefined threshold. Thus, risk mitigation can be achieved by not preeminently deleting the media files without either obtaining the user's explicit authorization or calculating a low relevancy value with a corresponding a high confidence value indicating that deleting the media files correctly accords with the user's actual preferences.

In process 150 of method 100, the user is asked for additional feedback regarding the user's preferences for certain of the media files. For example, for borderline media files (e.g., media files located near a boundary between medium relevancy to be archived and low relevancy to be discarded) the user is asked what action or what relevancy measure should be assigned to the media files. Thus, media files having a relevancy value near a boundary between two different actions can be assigned the correct action. Additionally, for media files with a low confidence values, the user can be asked what action or what relevancy value should be assigned to the media files.

These borderline and low-confidence media files together with the user's preferred organizational action for the media files can be stored and used as supplemental training data. The supplemental training data can then be applied as feedback to improve the relevancy algorithm. Using the supplemental training data, the relevancy algorithm can be revised and adjusted to minimize the combined error of the training data and the supplemental training data

In step 160 of method 100, relevancy values are calculated for the remaining media files, and the media files can be sorted into categories according to their respective relevancy values. The corresponding organizational action for all media files within a given category. As discussed above the relevancy values can be continuous or discrete. When the relevancy value is discrete, there can be a one-to-one correspondence between the relevancy value and the action. In certain implementations, e.g., using a neural network, the relevancy value is not a numeric value but is a label corresponding to the action itself. When the relevancy value can assume more values than there are actions, then the space of relevancy value is partitioned into regions or intervals (i.e., categories) corresponding to the actions.

Further, in certain implementations, the relevancy value can be a multi-valued array (e.g., a vector including a first number representing importance and a second number representing timeliness, as discussed in the foregoing), such that the space on which the relevancy value is represented is a multi-dimensional space, and the regions corresponding to the organizational actions are multi-dimensional shapes or subspaces within the multi-dimensional space, the action subspaces being separated by multi-dimensional boundaries or thresholds.

The actions taken after categorizing the media files according to their relevance values can include, e.g., organizing and storing the media files into folders (e.g., a frequent-use folder, a work folder, a friends folder, a family folder, a vacations folder, a nature folder, a hobby folder, a memories, a special events/occasions folder, etc.), backing up the media files using remote storage, compressing the media files, archiving the media files, tarring and zipping the media files, applying security protections to the media files (e.g., hiding the media files or otherwise limiting access to designated users and applying password protections to further limit access), placing the media files in a folder having a predefined expiration time at which the files will be deleted, placing the media files in a trash folder, and permanently deleting the media files.

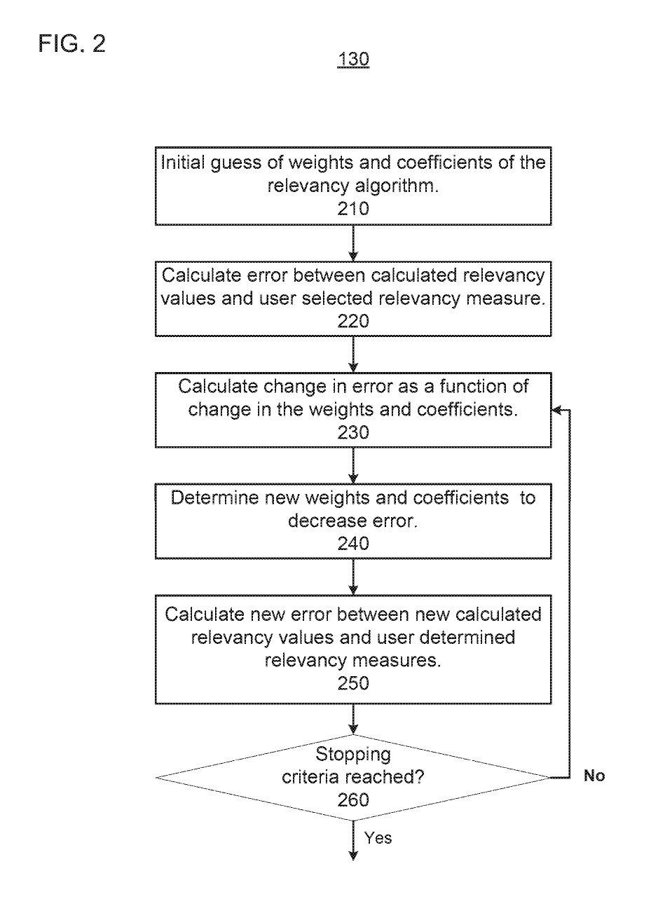

FIG. 2 shows a flow diagram of an implementation of Process 130 for training the relevancy algorithm using the training data.

In step 210 of process 130, an initial guess is generated for the weights and coefficients of the relevancy algorithm. For example, the initial guess can be based on preferences of an average person. In certain implementations, a user can select a default initial guess by self-identifying among several default categories (e.g., the default options might be “artist,” “car enthusiast,” “nature enthusiast,” “workaholic,” “teenager,” “social extrovert,” etc.). The initial guess can then be determined using the user self-identification.

In step 220 of process 130, a total error (sometimes referred to as a cost function) is measured between the relevancy measures and the respective relevancy values calculated from the training data. The relevancy values are calculated using the relevancy algorithm with the current weights and coefficients. For an implementation using a neural network, the relevancy values are calculated using the neural network with its corresponding current weights, coefficients, and threshold values.

In step 230 of process 130, a change in the error as a function of the change in the weights can be calculated (e.g., an error gradient), and this change in the error can be used to select a direction and step size for a subsequent change to the weights and coefficients of the relevancy algorithm. Calculating the gradient of the error in this manner is consistent with certain implementations of a gradient descent optimization method. In certain other implementations, as would be understood by one of ordinary skill in the art, this step can be omitted and/or substituted with another step in accordance with another optimization algorithm (e.g., a non-gradient descent optimization algorithm like simulated annealing or a genetic algorithm).

In step 240 of process 130, a new set of weights and coefficients are determined for the relevancy algorithm.

In step 250 of process 130, a new total error a value is calculated using the updated weights and coefficients of the relevancy algorithm.

In step 260 of process 130, the new total error and the total number of iterations performed so far is compared to predefined stopping criteria. For example, the stopping criteria can be satisfied if either the new total error falls below a predefined threshold or if the maximum number of iterations has been reached. When the stopping criteria is not satisfied process 130 will continue back to the start of the iterative loop by returning and repeating step 230 using the new weights and coefficients (the iterative loop includes steps 230, 240, 250, and 260). When the stopping criteria are satisfied process 130 is completed.

In addition to the implementation for error minimization shown in FIG. 2, process 130 can use one of many other known minimization methods, including, e.g., local minimization methods, convex optimization methods, and global optimization methods.

When the cost function (e.g., the total error) has local minima that are different from the global minimum, a robust stochastic optimization process is beneficial to find the global minimum of the cost function. Examples, of optimization method for finding a local minimum can be one of a Nelder-Mead simplex method, a gradient-descent method, a Newton's method, a conjugate gradient method, a shooting method, or other known local optimization method. There are also many known methods for finding global minima including: genetic algorithms, simulated annealing, exhaustive searches, interval methods, and other conventional deterministic, stochastic, heuristic, and metatheuristic methods. Any of these methods can be used to optimize the weights and coefficients of the relevancy algorithm. Additionally, neural networks can be optimized using a back-propagation method.

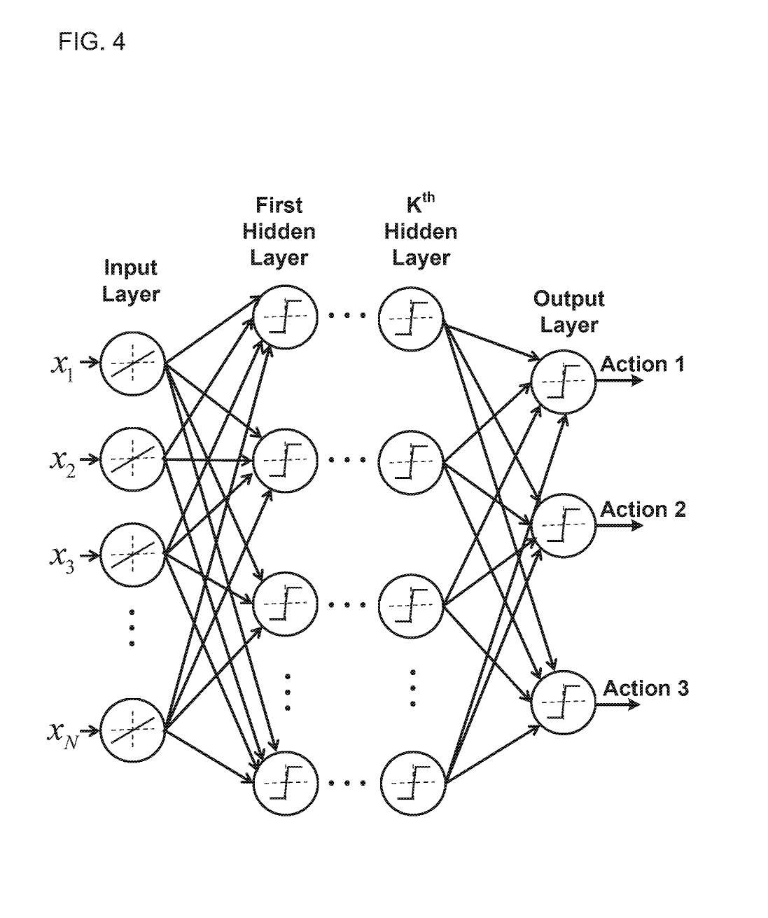

As discussed in the foregoing, the relevancy algorithm can calculate the relevancy values using a weighted sum and/or a neural network. FIG. 4 shows an example of an artificial neural network (ANN) having N inputs (e.g., relevancy parameters), K hidden layers, and three output corresponding to the organization actions. Each layer is made up of nodes (also called neurons), and each node performs a weighted sum of the inputs and compares the result of the weighted sum to a threshold to generate an output. ANNs make up a class of functions for which the members of the class are obtained by varying thresholds, connection weights, or specifics of the architecture such as the number of nodes and/or their connectivity. The nodes in an ANN can be referred to as neurons, and the neurons can have inter-connections between the different layers of the ANN system.

For example, a simple ANN having three layers is called an autoencoder. The first layer has input neurons which send data via synapses to the second layer of neurons (i.e., the second layer being the first and only hidden layer in the autoencoder architecture), the second layer is connected via more synapses to a third layer, which includes the output neurons.

More complex ANN systems will have more than three layers of neurons, and some have increased layers of input neurons and output neurons. The synapses store values called “weights” that manipulate the data in the calculations. An ANN is can be defined by three types of parameters: (i) the interconnection pattern between the different layers of neurons, (ii) the learning process for updating the weights of the interconnections, and (iii) the activation function that converts a neuron's weighted input to its output activation.

Mathematically, a neuron's network function m(x) is defined as a composition of other functions nᵢ(x), which can further be defined as a composition of other functions. This can be conveniently represented as a network structure, with arrows depicting the dependencies between variables, as shown in FIG. 4. A widely used type of composition is a nonlinear weighted sum, wherein m(x)=K(Σᵢwᵢnᵢ(x)), where K (commonly referred to as the activation function) is some predefined function, such as the hyperbolic tangent.

In FIG. 4, the neurons (i.e., nodes) are depicted by circles around a threshold function, the inputs are depicted as circles around a linear function, and the arrows indicate directed connections between neurons.

Networks, such as the ANN shown in FIG. 4, are commonly called feedforward because their graph is a directed acyclic graph. Networks with cycles are commonly called recurrent. ANNs are beneficial in part due to their ability to perform machine learning. Given a specific task to solve, such as organizing media files according to their relevancy, the class of functions F can learn by using a set of observations to find m* ∈ F which solves the task in some optimal sense. This entails defining a cost function C:F→ [symbol] such that, for the optimal solution m*,C(m*)≦C(m)∀m ∈ F (i.e., no solution has a cost less than the cost of the optimal solution). The cost function C is a measure of how far away a particular solution is from an optimal solution to the problem to be solved (e.g., the total error). Learning algorithms search through the solution space to find a function that has the smallest possible cost. In certain implementations, the cost is minimized over a sample of the data (i.e., the training data) rather than the entire distribution generating the data.

There are three major learning paradigms, each corresponding to a particular abstract learning task. These are supervised learning, unsupervised learning, and reinforcement learning. In supervised learning, which is used for training the relevancy algorithm, a set of training data is obtained, and the aim is to find a relevancy algorithm that generates results (i.e., relevancy values) closely matching the relevancy measures of the training data. In other words, relevancy algorithm infers the mapping implied by the training data; the cost function is related to the mismatch between the mapping expressed by the relevancy values and the user's preferences expressed by the relevancy measures of the training data.

In certain implementations, the cost function can use the mean-squared error to minimize the average squared error between the network's output, and the target value over all the example pairs. By minimizing this cost function using gradient descent for the class of neural networks called multilayer perceptrons (MLP), the backpropagation algorithm can be used for training neural networks.

Training a neural network model essentially means selecting one model from the set of allowed models (or, in a Bayesian framework, determining a distribution over the set of allowed models) that minimizes the cost criterion. There are numerous algorithms available for training neural network models; most of them can be viewed as a straightforward application of optimization theory and statistical estimation. The optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithms can be classified into three categories: steepest descent (with variable learning rate, with variable learning rate and momentum, resilient backpropagation), quasi-Newton (Broyden-Fletcher-Goldfarb-Shanno, one step secant, Levenberg-Marquardt) and conjugate gradient (Fletcher-Reeves update, Polak-Ribiére update, Powell-Beale restart, scaled conjugate gradient). Evolutionary methods, such as gene expression programming, simulated annealing, expectation-maximization, non-parametric methods and particle swarm optimization, can also be used for training neural networks.

On particular type of ANN that has beneficial properties for pattern recognition in images is a convolutional neural network (CNN). CNNs are a type of feed-forward ANN\in which the connectivity pattern between neurons is inspired by the organization of the animal visual cortex, in which individual neurons are arranged in such a way that they respond to overlapping regions that tile the visual field. When used for image and visual pattern recognition, CNNs use multiple layers of small neuron collections which process portions of the input image, called receptive fields. The outputs of these collections are then tiled so that they overlap, to obtain a better representation of the original image. This processing pattern can be repeated over multiple layers having alternating convolution and pooling layers. Further, tiling, as described herein, allows CNNs to be robust to lateral offsets among images. Convolutional networks can include local or global pooling layers, which combine the outputs of neuron clusters in the convolution layers. CNNs can also include various combinations of convolutional and fully connected layers, with pointwise nonlinearity applied at the end of or after each layer. To reduce the number of free parameters and improve generalization, a convolution operation on small regions of input is introduced. One major advantage of convolutional networks is the use of shared weight in convolutional layers, which means that the same filter (weights bank) is used for each pixel in the layer; this both reduces memory footprint and improves performance. Compared to other image classification algorithms, CNNs can use relatively little pre-processing. This means that the network is responsible for learning the filters that in traditional algorithms were hand-engineered. The lack of dependence on prior knowledge and human effort in designing features is a major advantage for CNNs.

In certain implementations, a scale-invariant feature transform (SIFT) can be used in the relevancy algorithm in concrete with a weighted sum algorithm (e.g., linear regression) and/or ANN algorithm described above. The SIFT algorithm is an algorithm to detect and describe local features in images. For any object in a digital image of a media file, interesting points on the object can be extracted to provide a feature description of the object. This description, extracted from a training image, can then be used to identify the object when attempting to locate the object in a test image containing many other objects. Thus, by detecting the same or similar object in separate media files, correlations between the media files can be determined. To perform reliable recognition, it is significant that the features extracted from the training image be detectable even under changes in image scale, noise and illumination. Such points usually lie on high-contrast regions of the image, such as object edges.

Another significant characteristic of these features is that the relative positions between them in the original scene are invariant from one image to another. For example, if the four corners of a door were used as features, they would work regardless of the door's position; but if points in the frame were also used, the recognition would fail if the door is opened or closed. In certain implementations, the SIFT algorithm can be used to detect and use a large number of features from the images, thereby reducing errors introduced by local variations in the average error of all feature matching errors.

Accordingly, the SIFT can robustly identify objects even among clutter and under partial occlusion because the SIFT feature descriptor is invariant to uniform scaling, orientation, and partially invariant to affine distortion and illumination changes.

The perform the SIFT algorithm, SIFT keypoints of objects are first extracted from a set of reference images, such as those in the training data which in certain implementations can be further supplemented by additional features detected in remaining media files. These SIFT keypoints can be stored in a database. An object is recognized in a new image by individually comparing each feature from the new image to this database and finding candidate snatching features based on Euclidean distance of their feature vectors. From the full set of matches, subsets of keypoints that agree on the object and its location, scale, and orientation in the new image are identified to filter out good matches. The determination of consistent clusters is performed rapidly by using an efficient hash table implementation of the generalized Hough transform. Each cluster of three or more features that agree on an object and its pose is then subject to further detailed model verification and subsequently outliers are discarded. Finally, the probability that a particular set of features indicates the presence of an object is computed, given the accuracy of fit and number of probable false matches. Object matches that pass all these tests can be identified as correct with high confidence.

In certain implementations, the relevancy algorithm can variously use combinations of weighted sums, ANNs (e.g., an autoencoder and/or a CNN), and a SIFT algorithm to calculate relevancy values for the media files. The relevancy algorithm can be trained using machine learning and the training data to iterate to a combination of weights and coefficients minimizing a cost function (e.g., the total error discussed in the foregoing). For example, in certain implementations, the facial recognition can be performed using a CNN to generate discrete results, such as the number of faces, characteristics and recurring patterns of the faces (e.g., eyes open, smiling mouths, etc.), and/or identity of the faces, and these outputs are used as inputs to another ANN or a weighted sum used to calculate the relevancy values.

In certain implementations, certain of the weights and/or components of the relevancy algorithm are constrained during the optimizations, while other values are varied to minimize the cost function. For example, the facial recognition can be constrained, but the weights for the connections from the discrete outputs from facial recognition CNN to a subsequent ANN or weighted sum can be allowed to vary.

In certain implementations, a SIFT or CNN algorithm can be used for pattern recognition to detect parameter 326 of the parameter options 310, a CNN can be used for facial recognition to detect parameter 312 of 310, and a shallower ANN or a weighted sum can receive discrete outputs from the above algorithms for parameters 312 and 326 together with discrete values for the remaining parameters to calculate the relevancy values.

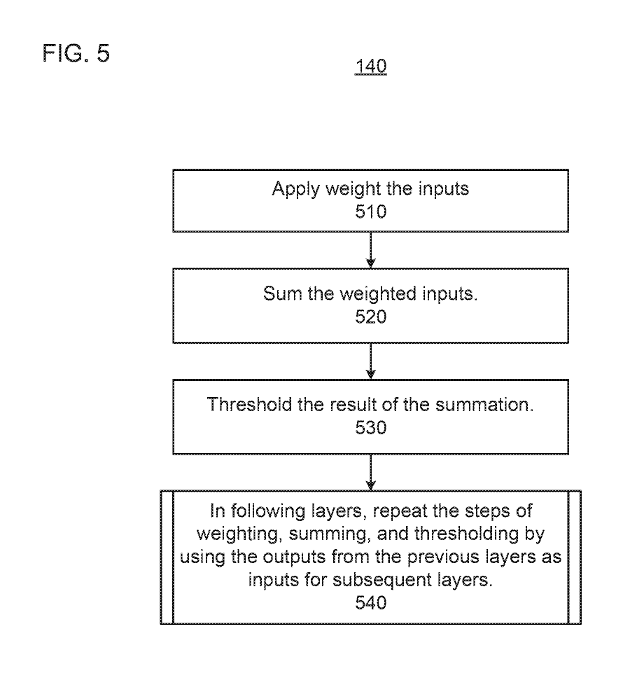

FIG. 5 show a flow diagram of an implementation of process 140 to calculate the relevancy values of the media files. The implementation of process 140 shown in FIG. 5 corresponds to calculating the relevancy values using one possible implementation of a neural network. When a weighted sum is used, process 140 can be modified to calculate the relevancy values using an expression such as

$$RV = {\sum }_{i = 1}^{{N}_{w}} {w}_{i} {f}_{i} ( {p}_{i} ) + {\sum }_{i = 1}^{{N}_{w}} {\sum }_{i \neq j}^{{N}_{w}} {w}_{ij} {g}_{ij} ( {p}_{i} , {p}_{j} ) .$$

In step 510, the weights are applied to the respective inputs corresponding to the connections between neurons (i.e., nodes).

In step 520 the weighted inputs to the respective neurons are summed.

In step 530 respective thresholds are applied to the weighted sums of the respective neurons.

In process 540 the steps of weighting. summing, and thresholding are repeated for subsequent layers.

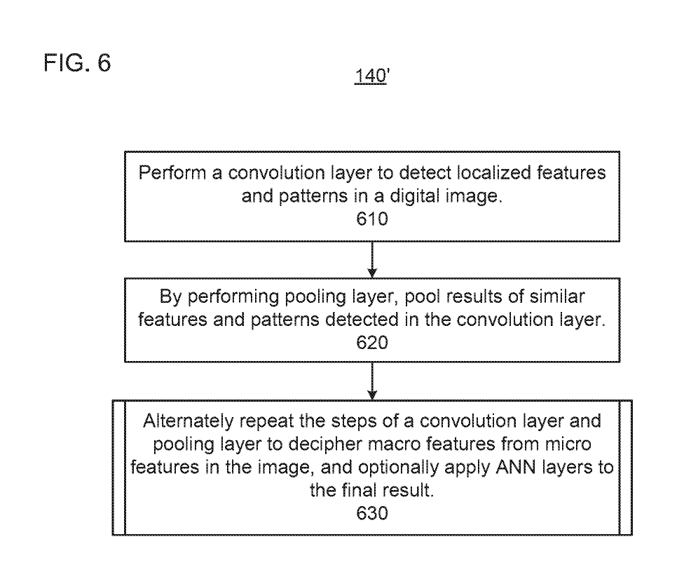

FIG. 6 show a flow diagram of another implementation of process 140 to calculate the relevancy values of the media files. The implementation of process 140′ shown in FIG. 6 corresponds to calculating the relevancy values using one possible implementation of a CNN.

In step 610, the calculations for a convolution layer are performed as discussed in the foregoing and in accordance with the understanding of convolution layers of one of ordinary skill in the art.

In step 620, the outputs from the convolution layer are the inputs into a pooling layer that is performed according to the foregoing description of pooling layers and in accordance with the understanding of pooling layers of one of ordinary skill in the art.

In process 630 the steps of a convolution layer followed by a pooling are repeated a predefined number of times. Following the convolution and pooling layers, the output from the last pooling layer can be fed to a predefined number of ANN layers that are performed according to the description provided for the ANN layers in FIG. 5.

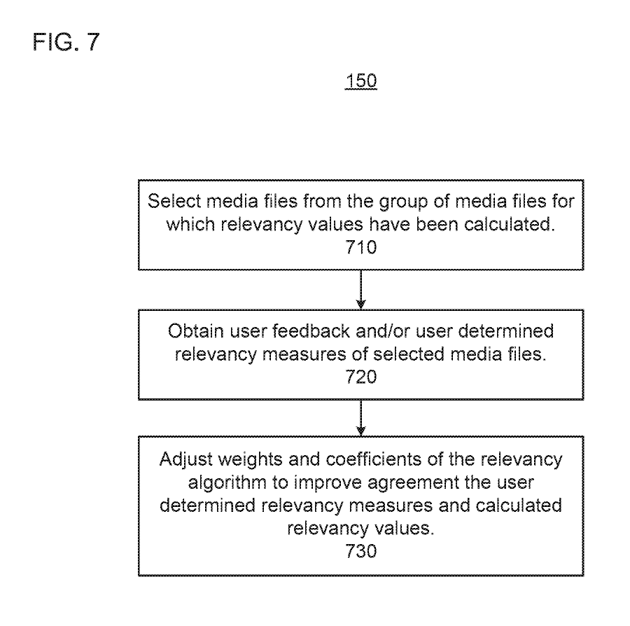

FIG. 7 show a flow diagram of an implementation of process 150 to adjust the weights and coefficients to improve the relevancy algorithm.

In step 710, after relevancy values have been calculated for several media files, a subset of media files can be selected from the set of media files for which relevancy value have been calculated. The selected subset of media files can be selected randomly or according to some figure of merit such as the relevancy values being close to a boundary between organizational actions or a confidence value indicating that there is low confidence in the calculated relevancy value. This selected subset of media files can be used as supplemental training data, as discussed in the foregoing.

In step 720, user feedback is obtained for the user's preferred organizational action and/or relevancy value for the media files in the supplemental training data. For example, for a given media file of the supplemental training data, the user can be asked to approve or disapprove of the calculated relevancy value and/or corresponding organizational action. Presumably the assigned relevancy value and/or organizational action will be correct for a high percentage of the media files of the supplemental training data, thus the user can rapidly scroll through the media files of the supplemental training date changing only the small percentage of relevancy values and/or organizational actions which run contrary to the user's preferences. Accordingly, the process of obtaining the user feedback for the supplemental training data can advantageously be streamlined and performed quickly and efficiently. The media files for which the relevancy values have been changed can be flagged, and, in certain implementations, the flagged media files can be weighted more heavily in calculating the cost function.

In step 730, additional training of the relevancy algorithm can be performed to further train the relevancy algorithm to minimize a cost function that includes the supplemental training data. In certain implementations, the minimization of the total error can be performed by applying different weights to the errors calculated from the media files of the original training data and to the errors calculated from the media files of supplemental training data. For example, the more recent supplemental training data can be weighted to influence the cost function more than the original training data. The updating and adjusting of the weights and coefficients can be performed using a method similar to the methods described for process 130.

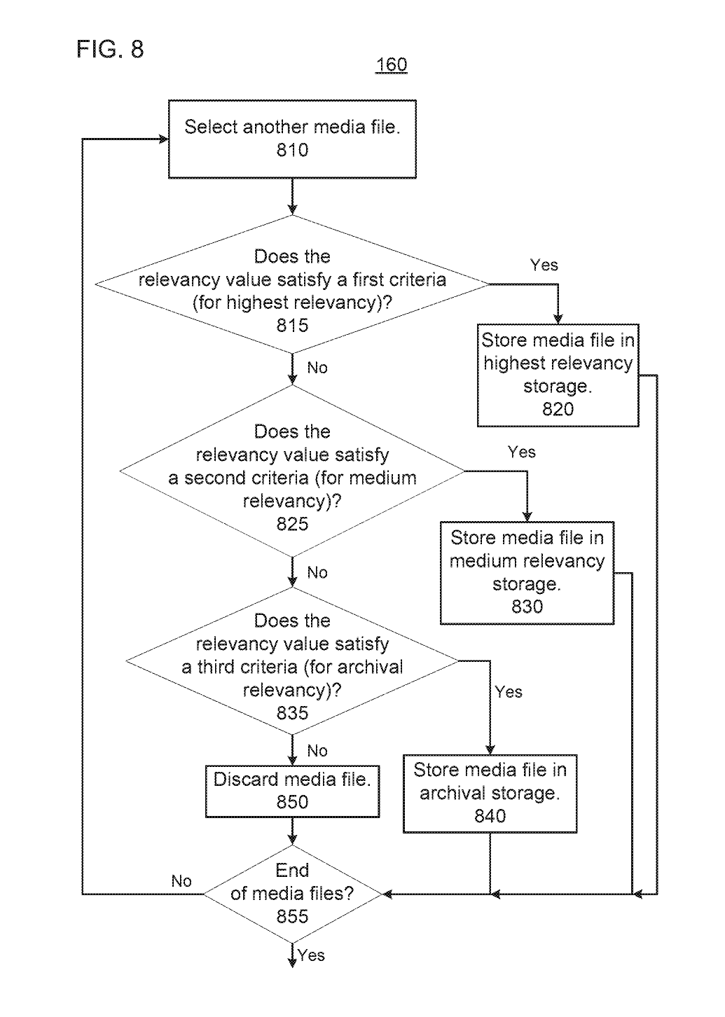

FIG. 8 show a flow diagram of an implementation of process 160 to determine actions based on the relevancy values. If the relevancy value is a continuous range of real numbers, for example, then the first, second, and third criteria applied in steps 815, 825, and 835 determine whether the relevancy value lies within three non-overlapping intervals of all relevancy values. For example, if the range of relevancy values is [0,10], then the first criteria can include an interval of relevancy values having a range of [7.5,10], the second criteria can include an interval of relevancy values having a range of [5,7.5), the third criteria can include can include an interval of relevancy values having a range of [2.5,5), and the discarded media files correspond to relevancy values in the interval [0,2.5).

In certain implementations, the relevancy values can be discrete and can have a one-to-one correspondence with the organizational actions. In this case, process 160 can be performed using a look-up table or a switch-case statement expressing the one-to-one correspondence between relevancy values and the organizational actions.

Additionally, process 160 can be implemented using relevancy values expressed in a multidimensional space and/or using discrete rather than continuous relevancy values. For example, in certain implementations, the number of relevancy values can be greater than the number of organizational actions, as discussed in the foregoing discussion with regards to process 160 and with regards to method 100.

As shown for the implementation of process 160 exemplified in FIG. 8, process 160 can be performed using a series of decision points in steps 815, 825, and 835, which branch off to organizational actions in steps 820, 830, 840, and 850. Each of the decision points performs an inquiry into whether the relevancy value of a selected media file satisfies a respective set of organizational action selection criteria. For example, the actions shown in steps 820, 830, 840, and 850 correspond to storing the media files in respective storages having a hierarchy of relevancies, from the highest relevancy for step 820 to the lowest relevancy for step 850.

After all inquiries in steps 815, 825, and 835 have been made for a given media file and the appropriate action has been selected, then step 855 inquiries whether the end of the media files has been reached. If the end has been reached, then process 160 is complete. Otherwise, process 160 loops back from step 855 to step 810 and selects another media file on which to perform an organizational action.

In certain implementations, as discussed in the foregoing, process 160 can have more than or less than four organizational actions.

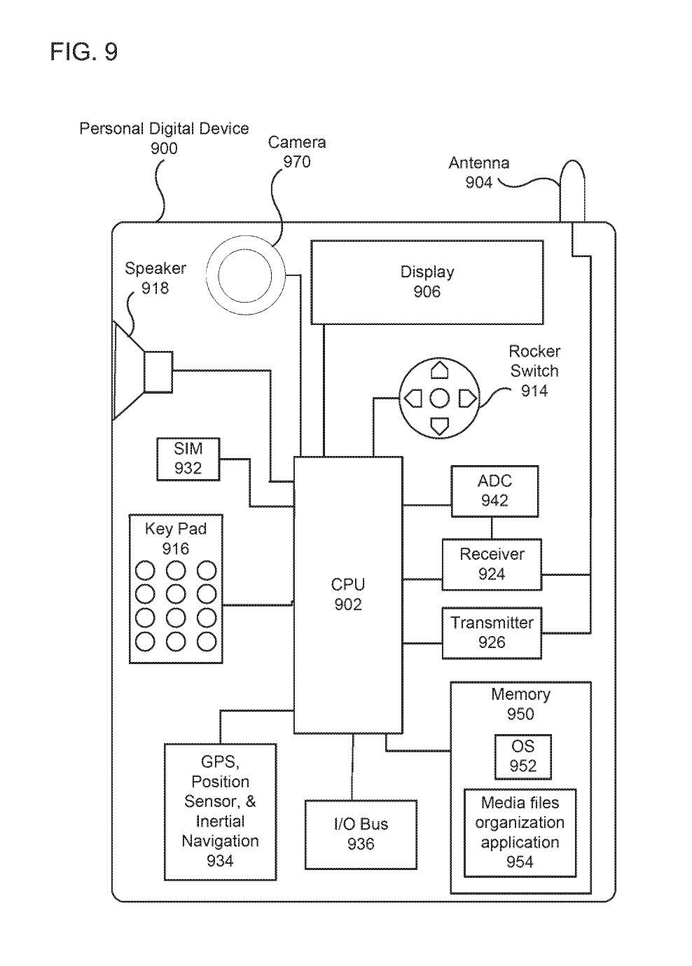

The PDD used in performing method 100 can be a smartphone, cellular phone, tablet computer, digital camera, a video camera, a personal or desktop computer, etc. FIG. 9 shows a block diagram illustrating one implementation of a personal digital device (PDD) 900. The PDD 900 can perform the method 100 of organizing media. The PDD 900 includes processing circuitry configured to perform the methods described herein. For example, the PDD 900 can include a processor 902 coupled to an internal memory 950, to a display 906 and to a subscriber identity module (SIM) 932 or similar removable memory unit. A processor 902 can be, for example, an ARM architecture CPU such as the Cortex A53 by ARM Inc. or a Snapdragon 810 by Qualcomm, Inc. The processor 902 can also be an Intel Atom CPU by Intel Corporation.

The PDD 900 can have an antenna 904 that is connected to a transmitter 926 and a receiver 924 coupled to the processor 902. The receiver 924 and portions of the processor 902 and the internal memory 950 can be used for network communications. The PDD 900 can further have multiple antennas 904, receivers 924, and/or transmitters 926. The PDD 900 can also include a keypad 916 or miniature keyboard and menu selection buttons or rocker switch 914 for receiving user inputs. The PDD 900 can also include a GPS device 934 for position sensing and/or inertial navigation. The GPS device 934 can be coupled to the processor and used for determining time and location coordinates of the PDD 900. Additionally, the display 906 can be a touch-sensitive device that can be configured to receive user inputs. The PDD 900 can include a digital camera to acquire the images, as well as functionality for receiving and sharing images and media files via social media and functionality for capturing image displayed on the display 906.

The processor 902 can be any programmable microprocessor, microcomputer or multiple processor chip or chips that can be configured by software instructions (applications) to perform a variety of functions, including functions of various embodiments described herein. The PDD 900 can include multiple processors 902.

Software applications can be stored in the internal memory 950 before they are accessed and loaded into the processor 902. The processor 902 can include or have access to the internal memory 950 sufficient to store the software instructions. The internal memory 950 can also include an operating system (OS) 952. The internal memory 950 can also include a media file organization application 954 that preforms, among other things, the method 100 as described in the foregoing, thus providing additional functionality to the PDD 900.

Additionally, the internal memory 950 can be a volatile or nonvolatile memory, such as flash memory, or a mixture of both. For the purposes of this description, a general reference to memory refers to all memory accessible by the processor 902, including internal memory 950, removable memory plugged into the PDD 900, and memory within the processor 902 itself, including a secure memory.

The PDD 900 can also include an input/output (I/O) bus 936 to receive and transmit signal to peripheral devices and sensors, or to communicate with embedded processors of the motor vehicle.

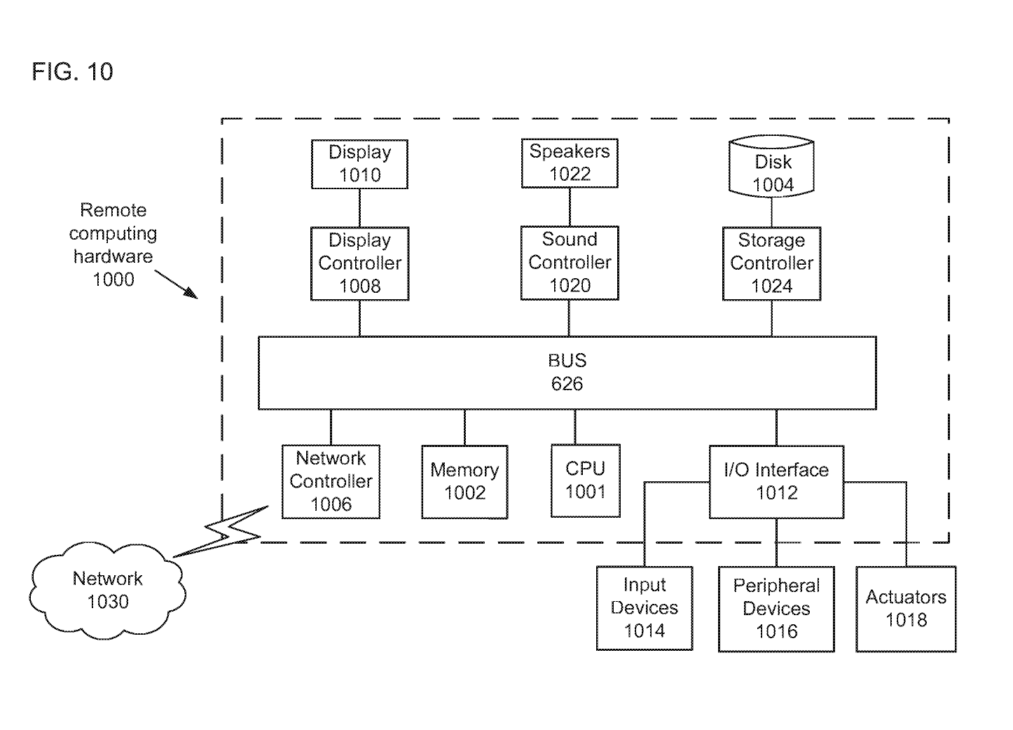

In certain implementations, method 100 is performed using remote computing hardware, while some less computationally intensive and memory intensive tasks of method 100 are performed on the PDD 900. FIG. 10 illustrates a block diagram of the remote computing hardware 1000, which performs the methods and processes described herein including method 100. Process data and instructions may be stored in a memory 1002. The process data and instructions may also be stored on a storage medium disk 1004 such as a hard drive (HDD) or portable storage medium or may be stored remotely. Further, the instructions may be stored on CDs, DVDs, in FLASH memory, RAM, ROM, PROM, EPROM, EEPROM, hard disk or any other information processing device with which the remote computing hardware 1000 communicates, such as a server, computer, or any non-transitory computer readable medium.

Further, functions of the remote computing hardware 1000 may be performed using a utility application, background daemon, or component of an operating system, or combination thereof, executing in conjunction with CPU 1001 and an operating system such as Microsoft WindowsEmbedded CE, UNIX, Solaris, LINUX, Apple XOS or iOS and other systems known to those skilled in the art.

CPU 1001 may be a Xenon or Core processor from Intel of America or an Opteron processor from AMD of America, or may be other processor types that would be recognized by one of ordinary skill in the art. Alternatively, the CPU 1001 may be implemented on an FPGA, ASIC, PLD or using discrete logic circuits, as one of ordinary skill in the art would recognize. Further, CPU 1001 may be implemented as multiple processors cooperatively working in parallel to perform the instructions of the inventive processes described above.

The remote computing hardware 1000 in FIG. 10 also includes a network controller 1006, such as an Intel Ethernet PRO network interface card from Intel Corporation of America, for interfacing with a network 1030. The network 1030 can be a public network, such as the Internet, or a private network such as an LAN or WAN network, or any combination thereof and can also include PSTN or ISDN sub-networks. The network 1030 can also be wired, such as an Ethernet network, or can be wireless such as a cellular network including EDGE, 3G and 4G wireless cellular systems. The network 1030 can also be Wi-Fi, Bluetooth, or any other wireless form of a communication that is known.

The remote computing hardware 1000 further includes a display controller 1008 for interfacing with a display 1010. A general purpose I/O interface 1012 interfaces with input devices 1014 as well as peripheral devices 1016. The general purpose I/O interface also can connect to a variety of actuators 1018.

A sound controller 1020 is also provided in the remote computing hardware 1000 to interface with speakers/microphone 1022 thereby providing sounds and/or music.

A general purpose storage controller 1024 connects the storage medium disk 1004 with a communication bus 1026, which may be an ISA, EISA, VESA, PCI, or similar, for interconnecting all of the components of the remote computing hardware 1000. Descriptions of general features and functionality of the display 1010, input devices 1014 (e.g., a keyboard and/or mouse), as well as the display controller 1008, storage controller 1024, network controller 1006, sound controller 1020, and general purpose I/O interface 1012 are omitted herein for brevity as these features are known.

Functions and features of the media file organization methods as described herein can be executed using cloud computing. For example, one or more processors can execute the functions of optimizing the relevancy algorithm and calculating the relevancy values. The one or more processors can be distributed across one or more cloud computing centers that communicate with the PDD 900 via a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized processing locations and accessible to multiple users who interact with the centralized processing locations through individual terminals.

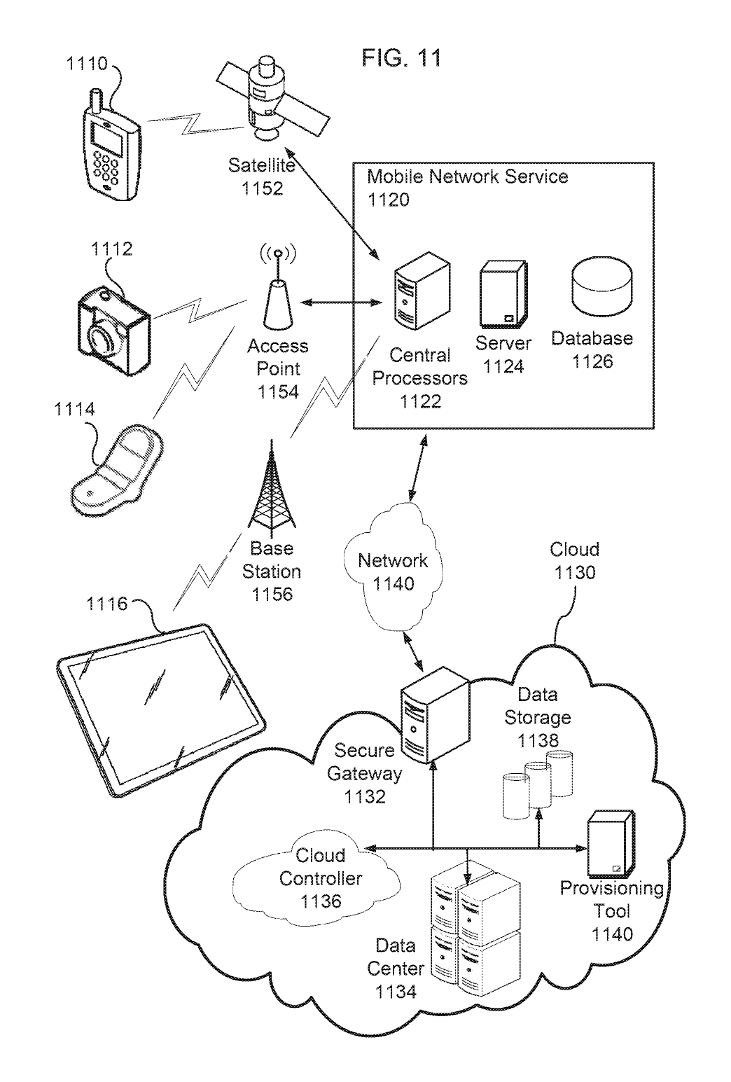

FIG. 11 shows an example of cloud computing, wherein various types of PDDs 900 the can connect to a network 1140 using either a mobile device terminal or a fixed terminal. For example, FIG. 11 shows a PDD 900 that is a smartphone 1110 connecting to a mobile network service 1120 through a satellite connection 1152. Similarly, FIG. 11 shows a PDD 900 that is a digital camera 1112 and another PDD 900 that is a cellular phone 1114 connected to the mobile network service 1120 through a wireless access point 1154, such as a femto cell or Wi-Fi network. Further, FIG. 11 shows a PDD 900 that is a tablet computer 1116 connected to the mobile network service 1120 through a wireless channel using a base station 1156, such as an Edge, 3G, 4G, or LTE Network, for example. Various other permutations of communications between the types of PDDs 900 and the mobile network service 1120 are also possible, as would be understood to one of ordinary skill in the art. The various types of PDDs 900, such as the cellular phone 1114, tablet computer 1116, or a desktop computer, can also access the network 1140 and the cloud 1130 through a fixed/wired connection, such as through a USB connection to a desktop or laptop computer or workstation that is connected to the network 1140 via a network controller, such as an Intel Ethernet PRO network interface card from Intel Corporation of America, for interfacing with a network.

Signals from the wireless interfaces (e.g., the base station 1156, the wireless access point 1154, and the satellite connection 1152) are transmitted to the mobile network service 1120, such as an EnodeB and radio network controller, UMTS, or HSDPA/HSUPA. Requests from mobile users and their corresponding information are transmitted to central processors 1122 that are connected to servers 1124 providing mobile network services, for example. Further, mobile network operators can provide services to the various types of PDDs 900. For example, these services can include authentication, authorization, and accounting based on home agent and subscribers' data stored in databases 1126, for example. The subscribers' requests can be delivered to the cloud 1130 through a network 1140.

As can be appreciated, the network 1140 can be a public network, such as the Internet, or a private network such as an LAN or WAN network, or any combination thereof and can also include PSTN or ISDN sub-networks. The network 1140 can also be a wired network, such as an Ethernet network, or can be a wireless network such as a cellular network including EDGE, 3G, 4G, HSPA+, and LTE wireless cellular systems. The wireless network can also be Wi-Fi, Bluetooth, or any other wireless form of a communication that is known.

The various types of PDDs 900 can each connect via the network 1140 to the cloud 1130, receive inputs from the cloud 1130 and transmit data to the cloud 1130. In the cloud 1130, a cloud controller 1136 processes a request to provide users with corresponding cloud services. These cloud services are provided using concepts of utility computing, virtualization, and service-oriented architecture.

The cloud 1130 can be accessed via a user interface such as a secure gateway 1132. The secure gateway 1132 can, for example, provide security policy enforcement points placed between cloud service consumers and cloud service providers to interject enterprise security policies as the cloud-based resources are accessed. Further, the secure gateway 1132 can consolidate multiple types of a security policy enforcement, including, for example, authentication, single sign-on, authorization, security token mapping, encryption, tokenization, logging, alerting, and API control. The cloud 1130 can provide, to users, computational resources using a system of virtualization, wherein processing and memory requirements can be dynamically allocated and dispersed among a combination of processors and memories such that the provisioning of computational resources is hidden from the users and making the provisioning appear seamless as though performed on a single machine. Thus, a virtual machine is created that dynamically allocates resources and is therefore more efficient at utilizing available resources. A system of virtualization using virtual machines creates an appearance of using a single seamless computer even though multiple computational resources and memories can be utilized according to increases or decreases in demand. The virtual machines can be achieved using a provisioning tool 1140 that prepares and equips the cloud-based resources such as a processing center 1134 and a data storage 1138 to provide services to the users of the cloud 1130. The processing center 1134 can be a computer cluster, a data center, a mainframe computer, or a server farm. The processing center 1134 and data storage 1138 can also be collocated.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

1. A method of organizing a plurality of media files including respective digital images, the method comprising:
obtaining training data, the training data including a first subset of the plurality of media files and corresponding relevance measures, the relevance measures having been determined by a user;
training, via processing circuitry, a relevancy algorithm by adjusting weight values of a weighted sum of the relevancy algorithm to decrease a cost function representing a difference between the relevance measures of the first subset and corresponding relevancy values calculated using the relevancy algorithm, the weighted sum of the relevancy algorithm being a summation over metadata parameters and digital-image parameters of a media file of the first subset; and
performing, via the processing circuitry, predefined actions on the plurality of media files according to the relevancy values of the plurality of media files calculated using the relevancy algorithm.

2. The method of organizing the plurality of media files according to claim 1, further comprising:
selecting the first subset to represent a diversity among the metadata parameters and the digital-image parameters of the plurality of media files; and
obtaining the training data by, for each media file of the first subset,
displaying a representation of a digital image corresponding to a media file of the first subset,
receiving an input indicating a relevancy measure of the media file to generate the relevancy measure of the media files,
associating, via the processing circuitry, the relevancy measure with the media file.

3. The method of organizing the plurality of media files according to claim 1, further comprising:
calculating, using the relevancy algorithm, relevancy values corresponding to the plurality of media files; and
sorting, via the processing circuitry, the plurality of media files into action classes each corresponding to one of the predefined actions.

4. The method of organizing the plurality of media files according to claim 1, further comprising:
calculating, via the processing circuitry and using the relevancy algorithm, confidence values of the respective media files of the plurality of media files, each confidence value representing an uncertainty of either a relevancy value of a media file of the plurality of media files or a predefined action to be performed on the media file.

5. The method of organizing the plurality of media files according to claim 4, further comprising;
generating supplemental training data by selecting, using the confidence values, a second subset of the plurality of media files;
obtaining relevancy measures of media files of the supplemental training data, the relevance measures of the supplemental training data having been determined by the user; and
further adjusting the weight values of the relevancy algorithm to decrease a cost function including the training data and the supplemental training data, the cost function representing a difference between the relevance measures and corresponding relevancy values determined using the relevancy algorithm, wherein
the second subset of the plurality of media tiles includes media files corresponding to a large uncertainty corresponding to either an assignment of the relevancy value or an assignment of the predefined action.

6. The method of organizing the plurality of media files according to claim 1, wherein the predefined actions performed on the plurality of media files include
storing a media file into at least one folder configured for frequent usage, when the relevancy value corresponding to the media files satisfies a first predefined criteria;
compressing the media file and storing the compressed media file into at least one folder configured for archival usage, when the relevancy value corresponding to the media files satisfies a second predefined criteria, and
discarding the media file into a trash folder, when the relevancy value corresponding to the media files satisfies a third predefined criteria, wherein
the first predefined criteria, the second predefined criteria, and the third predefined criteria are mutually exclusive.

7. The method of organizing the plurality of media files according to claim 1, wherein the relevancy algorithm calculates the relevancy values using the metadata parameters and the digital-image parameters of respective media files, wherein the metadata parameters and the digital-image parameters include one or more of
a facial-recognition parameter,
a source parameter indicating a source of the media file, the source of the media file being a user of a device used to generate the media file, a website originating the media or a designation of an origin of the media file,
a location parameter indicating a location at which the media file was generated,
a time parameter indicating a time at which the media file was generated, p1 an edit-history parameter indicating a history of editing, annotating, cropping, or filtering of the media file,
a sharing parameter indicating a sharing of the media file on social media or a sharing of the media file with other users,
a copying parameter providing indicia of the media file being copied,
a frequency-of-access parameter indicating a frequency with which the media file has been accessed,
a recency-of-access parameter indicating how recently the media file has been accessed,
a blurriness parameter indicating a sharpness or a focus of the media file,
a pattern recognition parameter indicating spatial patterns in the media file, and
a manual settings parameter indicating manual settings of the device used to obtain the media file.

8. The method of organizing the plurality of media files according to claim 1, wherein the relevancy algorithm includes one or more of a weighted sum over predefined parameters, an artificial neural network, and a scale-invariant feature transform algorithm.

9. The method of organizing the plurality of media files according to claim 1, wherein the adjusting of the weight values of the relevance measure is performed using an optimization method that includes one or more of a back-propagation method, a Nelder-Mead simplex method, a gradient-descent method, a Newton's method, a conjugate gradient method, a shooting method, an expectation-maximization method, a non-parametric method, a particle swarm optimization method, a genetic algorithm method, a simulated annealing method, an interval method, a stochastic method, a heuristic method, and a metatheuristic method.

10. The method of organizing the plurality of media files according to claim 1, wherein the relevancy algorithm is trained using machine learning operating on the training data to assign a relevancy value to a media file of the plurality of media files, the relevancy value being assigned to approximate the relevancy measures of a subset of the training data that has the metadata parameters and the digital-image parameters that are similar to the metadata parameters and the digital-image parameters of the media file.

11. The method of organizing the plurality of media files according to claim 1, wherein the cost function includes one or more error measures indicating a difference between the calculated relevancy values and the corresponding user-determined relevancy measures of the training data, the one or more error measures including one or more of an L₁-norm, an L₂-norm, and a maximum-likelihood measure.

12. The method of organizing the plurality of media files according to claim 1, wherein the adjusting of the weight values of the weighted sum of the relevancy algorithm further includes
calculating the relevancy values using a convolution neural network including a convolution layer and a pooling layer to determine image patterns of a digital image of the media file, and
determining, using the determined image patterns, one or more of a facial recognition parameter and a pattern-recognition parameter used to calculate the relevancy values.

13. An apparatus, comprising:
a display configured to display a digital image representing a media file of a plurality of media files;
an interface configured to receive input from a user in response to the digital image displayed on the display; and
processing circuitry configured to
determine a first subset of the plurality of media files,
control the display to display the digital image representing the media file,
determine a relevancy measure associated with the media file based on the input of the user in response to the digital image displayed on the display,
generate training data, the training data including the first subset of the plurality of media files and the associated relevance measures of the first subset,
calculate a relevancy value of a media file of the plurality of media files using a relevancy algorithm that includes a weighted sum over metadata parameters and digital-image parameters of the media file,
train the relevancy algorithm by adjusting weight values of the relevancy algorithm to decrease a cost function representing a difference between the relevance measures of the training data and the corresponding relevancy values calculated using the relevancy algorithm, and
perform predefined actions on the plurality of media files according to the relevancy values of the plurality of media files calculated using the relevancy algorithm.

14. The apparatus according to claim 13, wherein the processing circuitry is further configured to
calculate, using the relevancy algorithm, confidence values of the plurality of media files, each confidence value representing an uncertainty of either a relevancy value of a media file of the plurality of media files or a predefined action to be performed on the media file.

15. The apparatus according to claim 14, wherein the processing circuitry is further configured to
generate supplemental training data by selecting, using the confidence values, a second subset of the plurality of media files,
obtain relevancy measures of media files of the supplemental training data, the relevance measures of the supplemental training data having been determined by the user, and
further adjust the weight values of the relevancy algorithm to decrease a cost function including the training data and the supplemental training data, the cost function representing a difference between the relevance measures and corresponding relevancy values determined using the relevancy algorithm, wherein
the second subset of the plurality of media files includes media files corresponding to a large uncertainty corresponding to either an assignment of the relevancy value or an assignment of the predefined action.

16. The apparatus according to claim 13, wherein the processing circuitry is further configured to perform the predefined actions on the plurality of media files by
storing a media file into at least one folder configured for frequent usage, when the relevancy value corresponding to the media files satisfies a first predefined criteria;
compressing the media file and storing the compressed media file into at least one folder configured for archival usage, when the relevancy value corresponding to the media files satisfies a second predefined criteria, and
discarding the media file into a trash folder, when the relevancy value corresponding to the media files satisfies a third predefined criteria, wherein
the first predefined criteria, the second predefined criteria, and the third predefined criteria are mutually exclusive.

17. The apparatus according to claim 13, wherein the processing circuitry is further configured to calculate the relevancy values using one or more of a weighted sum over predefined parameters, an artificial neural network, and a scale-invariant feature transform algorithm.

18. The apparatus according to claim 13, wherein the processing circuitry is further configured to calculate the relevancy values using the metadata parameters and the digital-image parameters of respective media files, wherein the metadata parameters and the digital-image parameters include one or more of
a facial-recognition parameter,
a source parameter indicating a source of the media file, the source of the media file being a user of a device used to generate the media file, a website originating the media file, or a designation of an origin of the media file,
a location parameter indicating a location at which the media file was generated,
a time parameter indicating a time at which the media file was generated,
an edit-history parameter indicating a history of editing, annotating, cropping, or filtering of the media file,
a sharing parameter indicating a sharing of the media file on social media or a sharing of the media file with other users,
a copying parameter providing indicia of the media file being copied,
a frequency-of-access parameter indicating a frequency with which the media file has been accessed,
a recency-of-access parameter indicating how recently the media file has been accessed,
a blurriness parameter indicating a sharpness or a focus of the media file,
a pattern recognition parameter indicating spatial patterns in the media file, and
a manual settings parameter indicating manual settings of the device used to obtain the media file.

19. The apparatus according to claim 13, wherein the processing circuitry is further configured to
calculate the relevancy values using a convolution neural network including a convolution layer and a pooling layer to determine image patterns of a digital image of the media file, and
determine, using the determined image patterns, one or more of a facial/object recognition parameter and a pattern-recognition parameter used to calculate the relevancy values.

20. A non-transitory computer-readable medium storing executable instructions, wherein the instructions, when executed by processing circuitry, cause the processing circuitry to perform a method comprising steps of:
obtaining training data, the training data including a first subset of the plurality of media files and corresponding relevance measures, the relevance measures having been determined by a user;
training, via processing circuitry, a relevancy algorithm by adjusting weight values of a weighted sum of the relevancy algorithm to decrease a cost function representing a difference between the relevance measures of the first subset and corresponding relevancy values calculated using the relevancy algorithm, the weighted sum of the relevancy algorithm being a summation over metadata parameters and digital-image parameters of a media file of the first subset; and
performing, via the processing circuitry, predefined actions on the plurality of media files according to the relevancy values of the plurality of media files calculated using the relevancy algorithm.
